(19) United States
(12) Patent Application Publication
(10) Pub. No.: US 2008/0253720 A1
(43) Pub. Date: Oct. 16, 2008

(54) Optical module device

(75) Inventors: Takahiro Yamaguchi, Tokyo (JP); Yoshihiko Kobayashi, Tokyo (JP); Tsutomu Nakamura, Tokyo (JP)

Correspondence Address: JUNICHI MIMURA;OKI AMERICA INC., 1101 14TH STREET, N.W., SUITE 555, WASHINGTON, DC, 20005, US

(73) Assignee: Oki Electric Industry Co., Ltd.

(21) Appl. No.: 12/068,896

(22) Filed: Feb. 13, 2008

(30) Foreign Application Priority Data
Apr. 13, 2007 (JP) 2007-105857

(51) Int. Cl. G02B 6/26

(52) U.S. Cl. 385/89

(57) ABSTRACT

An optical module device includes an optical module having leads, a print substrate and a flexible substrate including a first region having a center and a peripheral areas, a second and a third region, the flexible substrate including first through-holes corresponding to the leads in the center area, a terminal and a metalized trace formed in the second and third regions respectively, and a protection layer formed on its surface at the peripheral area and in the third region, wherein the flexible substrate further includes two second through-holes in the peripheral area, which is a location close to the third region, wherein the flexible substrate is bent along a line coupling the two second through-holes, and wherein the flexible substrate at it first region is fixed to the second end member by adhesive material injected into the second through-holes.

### CROSS-REFERENCE TO RELATED APPLICATION

This application claims the priority benefit of Japanese Patent Application No. 2007-105857, filed Apr. 13, 2007, the entire disclosure of which is incorporated herein by reference.

### BACKGROUND OF THE INVENTION

1. Field of the invention

The invention relates to an optical module device including an optical module for an optical communication and a print substrate, which is electrically connected to the optical module by a flexible substrate, specifically relates to the structure of the flexible substrate for the optical communication.

2. Description of the related art

The following references disclose the technology of a conventional optical module device including an optical module for an optical communication and a print substrate, which is electrically connected to the optical module by a flexible substrate.

Japanese Laid Open Patent Publication 2006-332648A (Reference 1)

Japanese Laid Open Patent Publication 2007-043496A (Reference 2)

The Reference 1 discloses a trace connection structure between a multi-pin coaxial module and circuit substrate by using a flexible substrate. The Reference 2 discloses an optical transceiver using a flexible substrate.

An optical module device in the related art is explained below with reference to FIGS. 7A and 7B, FIGS. 8A and 8B, FIGS. 9A and 9B and FIGS. 10A and 10B. FIG. 7A is a front view, partially in cress-section and partially schematic, of an optical module device in the related art, and FIG. 7B is a plan view of a flexible substrate used in the optical module device illustrated in FIG. 7A. FIG. 8A is a left-side view of a first optical module and a second optical module used in the optical module device illustrated in FIG. 7A, and FIG. 8B is a back view of the first optical module illustrated in FIG. 8A. FIG. 9A is a front view of the first and the second optical module illustrated in FIG. 8A on which the flexible substrate is connected, and FIG. 9B is a left-side view of the first and the second optical module illustrated in FIG. 8A on which the flexible substrate is connected. FIG. 10A is an enlarged cross-sectional view of the flexible substrate illustrated in the FIG. 9B taken along line A1-A2, and FIG. 10B is an enlarged cross-sectional view of the flexible substrate illustrated in the FIG. 9B taken along line B1-B2.

As shown in FIG. 8A, the optical module device includes a first optical module 10 and a second optical module 20. The first optical module 10 acting as an optical transmitter and an optical receiver includes a first end member 11 and a second end member 12. The second optical module 20 includes a third end member 21, which is optically coupled and physically connectable and disconnectable with the first end member 11 of the first optical module 10, and a fourth end member 22 to which an optical fiber is connected. The first and the second optical modules 10 and 20 being connected to each other are attached to a chassis 40 at the third end member 21 of the second optical module 20. The second end member 12 of the first optical module 10 is connected to a print substrate 60, on which electric components 61 are mounted, by a flexible substrate 50, which is bent.

As shown in FIGS. 8A and 8B, the first optical module 10 includes a plurality of leads 13-1˜13-4 for sending and receiving electric signals (hereinafter they are called signal leads) and a lead 14 for grounding to earth (hereinafter it is called a ground lead), which are projected from the surface of its second end member 12, wherein the ground lead 14, which is located in the center area of the surface, is surrounded by the signal leads 13-1˜13-4, which are located in the peripheral area of the surface.

As shown in FIGS. 9A and 9B, the flexible substrate 50, which is connected to the second end member 12 of the first optical module 10, consists of a first region 51 for fixing the signal leads 13-1˜13-4 and the ground leads 14, a second region 53 in which terminals 53A are formed, and a third region 52 located between the first and the second regions. The first region 51, which is round-shaped, includes a center area 200 and a peripheral area 210 surrounding the center area 200. The second and the third regions 53 and 52 are rectangular-shaped. In the first region 51, a plurality of through-holes 54-1˜54-4 (herein after they are called signal through-holes), each of which corresponds to one of the signal leads 13-1˜13-4, and a through-hole 55 (herein after it is called a ground through-hole), which corresponds to the ground lead 14, are formed in the center area 200. As shown in FIG. 10A, each signal lead 13-1˜13-4 is inserted into one of the signal through-holes 54-1˜54-4, and then, is fixed by solder 58, and the ground lead 14 is inserted into the ground through-hole 55, and then, is fixed by solder 58. The suppress part of each leads 13-1˜13-4 and 14 is trimmed, and as a result, the flexible substrate 50 is mounted on and fixed to the first optical module 10 at the second end member 12. The signal through-holes 54-1˜54-4 are electrically connected to the terminals 53A by metalized trace 56 formed on the surface of the flexible substrate 50 in the third region 52. As shown in FIGS. 9B, 10A and 10B, the flexible substrate 50 in the peripheral area 210 of the first region 51 and in the entire third region 52 including the surface of the metalized trace 56 is covered by a protection layer 57. The flexible substrate 50 in the second region 53 including the surface of the terminals 53A is exposed.

A method of manufacturing the optical module device having the structure described above is explained as follows with reference to several drawings.

First, as shown in FIGS. 9A, 9B and 10A, each signal lead 13-1˜134 is inserted into one of the signal through-holes 54-1˜54-4, and then, is fixed by solder 58, and the ground lead 14 is inserted into the ground through-hole 55, and then, is fixed by solder 58. The suppress part of each leads 13-1˜13-4 and 14 are trimmed, and as a result, the flexible substrate 50 is mounted on and fixed to the first optical module 10 at the second end member 12. Next, as shown in FIGS. 7A and 7B, by adding force to the flexible substrate 50, which is in condition shown in FIG. 9A, from the optical module side (from the right to the left on the drawing), the flexible substrate 50 is bent at 90-degree angle along the bending line 51A (shown as the broken line), which is just under the location where the signal through-holes 54-1 and 54-4 and the ground through-holes 55 are disposed. Then, the second region 53 in which the terminals 53A are formed is mounted on unillustrated terminals formed on the print substrate 60 on which the electric components 61 are mounted, and then the second region 53 of the flexible substrate 50 is fixed on the print substrate 60 by solder. Then, the second optical module 20 having the optical fiber 30, which is attached to a chassis 40, is optically coupled with the first optical module 10.

In such an optical module device described above, the first optical module 10 emits an optical signal from its first end member 12 in response to the electric signal outputted from the electric components 61. The optical signal is received at the second optical module 20, and then, is transmitted to the optical fiber 30.

However, when the flexible substrate 50 is bent, the bending stress is concentrated at the bending line 51A. Specifically, since the surface of the center area 200 at the bending line 51a is not covered by the protection layer 57, the metalized traces 56 are broken.

### SUMMARY OF THE INVENTION

An objective of the invention is to solve the above-described problem and to provide an optical module having a flexible substrate on which metalized trace, which are not broken by bending the flexible substrate, is formed.

The objective is achieved by an optical module device including an optical module having a first end member at which an optical signal is transmitted and a second end member from which a plurality of leads are projected, a flexible substrate including a first region having a center area and a peripheral area at its one end, a second region at its other end and a third region between the first and the second regions, the flexible substrate including a plurality of first through-holes in which the leads are to be inserted in the center area, a terminal formed on its surface in the second region, a metalized trace formed on its surface in the third region for connecting one of the first through holes to the terminal and a protection layer formed on its surface at the peripheral area in the first region and in the third region, wherein the flexible substrate further includes at lease two second through-holes in the peripheral area in the first region, which is a location close to the third region, wherein the flexible substrate is bent along a bending line coupling the two second through-holes, and wherein the flexible substrate at it first region is fixed to the second end member of the optical module by adhesive material injected into the second through-holes, and a print substrate on which an electric component connecting to the terminal is mounted.

### BRIEF DESCRIPTION OF THE DRAWINGS

The invention will be more particularly described with reference to the accompanying drawings, in which:

FIG. 1A is a front view, partially in cress-section and partially schematic, of an optical module device, according to a first embodiment;

FIG. 1B is a plan view of a flexible substrate used in the optical module device illustrated in FIG. 1A;

FIG. 2A is a left-side view of a first optical module and a second optical module used in the optical module device illustrated in FIG. 1A;

FIG. 2B is a back view of the first optical module illustrated in FIG. 2A;

FIG. 3A is a left-side view of the first and the second optical module illustrated in FIG. 2A on which the flexible substrate of FIG. 1B is connected;

FIG. 3B is a back view of the first and the second optical module illustrated in FIG. 3A on which the flexible substrate of FIG. 1B is connected.;

FIG. 4A is an enlarged cross-sectional view of the flexible substrate illustrated in the FIG. 3B taken along line C1-C2;

FIG. 4B is an enlarged cross-sectional view of the flexible substrate illustrated in the FIG. 3B taken along line D1-D2; and

FIG. 5A is a left-side view of the optical module device on which the flexible substrate is connected to the first optical module, according to the first embodiment;

FIG. 5B is a plan view of the flexible substrate being attached to the first optical module;

FIG. 6A is a left-side view of an optical module device on which a flexible substrate is connected to a first optical module, according to a second embodiment;

FIG. 6B is a plan view of the flexible substrate being attached to the first optical module;

FIG. 7A is a left-side view, partially in cress-section and partially schematic, of an optical module device in the related art;

FIG. 7B is a plan view of a flexible substrate used in the optical module device illustrated in FIG. 7A;

FIG. 8A is a left-side view of a first optical module and a second optical module used in the optical module device illustrated in FIG. 7A;

FIG. 8B is a back view of the first optical module illustrated in FIG. 8A;

FIG. 9A is a left-side view of the first and the second optical module illustrated in FIG. 8A on which the flexible substrate is connected;

FIG. 9B is a back view of the first and the second optical module illustrated in FIG. 8A on which the flexible substrate is connected;

FIG. 10A is an enlarged cross-sectional view of the flexible substrate illustrated in the FIG. 9B taken along line A1-A2; and

FIG. 10B is an enlarged cross-sectional view of the flexible substrate illustrated in the FIG. 9B taken along line B1-B2.

### DETAILED DESCRIPTION OF THE PREFERRED EMBODIMENTS

The preferred embodiment of the invention as to an optical module device is explained together with drawings as follows. In each drawing, the same reference numbers designate the same or similar components through all embodiments.

### The First Embodiment

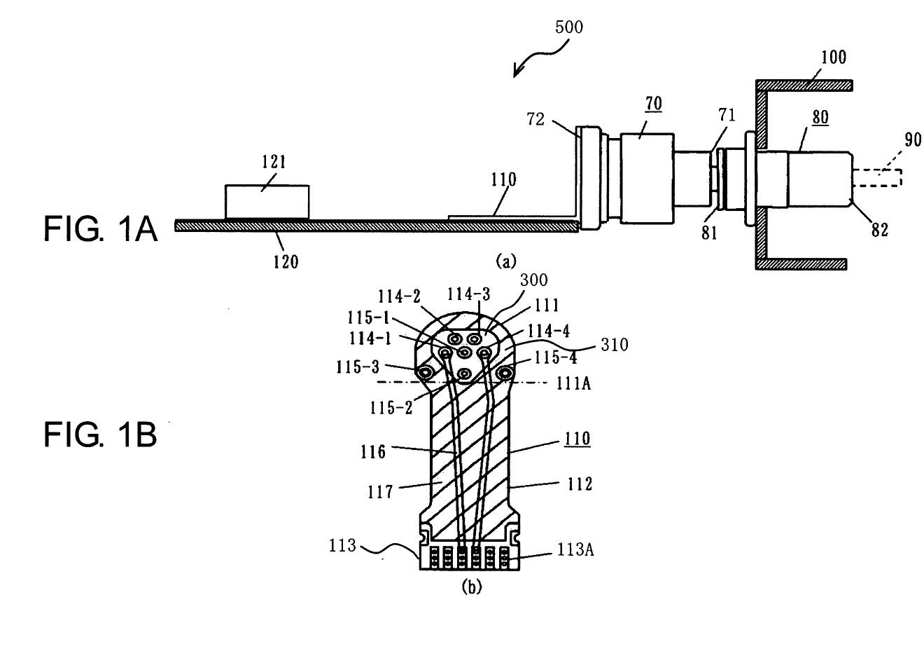

As shown in FIG. 1A, an optical module device 500 includes a first optical module 70 and a second optical module 80. The first optical module 70 for an optical communication such as a semiconductor Laser or a light receiving element includes a circular-shaped first end member 71 and a circular-shaped second end member 72. The second optical module 80 for an optical communication, such as a light receiving element or a condenser lens, includes a third end member 81, which is optically coupled and physically connectable and disconnectable with the first end member 71 of the first optical module 70 and a fourth end member 82 to which a optical fiber 90 is connected. The first and the second optical modules 70 and 80 being connected to each other are attached to a chassis 100 at the third end member 81 of the second optical module 80. The second end member 72 of the first optical module 70 is connected to a flat plate print substrate 120 formed of insulating material, on which electric components 121 are mounted, by a bendable and flexible substrate 110 (hereinafter it is simply called a flexible substrate), which is formed of insulating film. The flexible substrate 110 is used for transmitting electric signals.

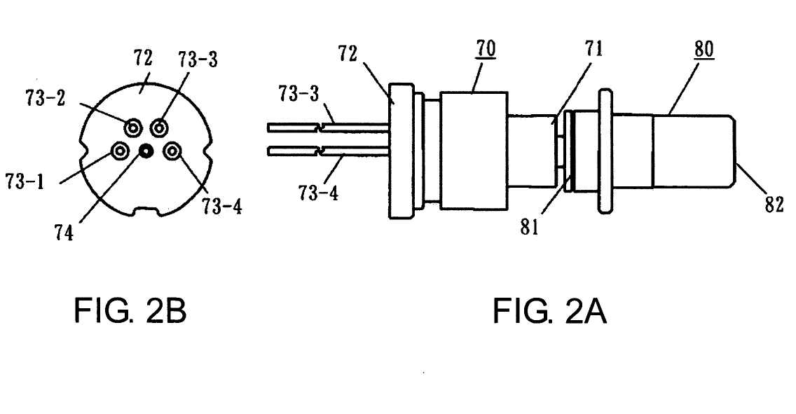

As shown in FIGS. 2A and 2B, the first optical module 70 includes a plurality of leads 73-1˜73-4 for sending and receiving electric signals (hereinafter they are called signal leads) and a lead 74 for grounding to earth (hereinafter it is called a ground lead), which are projected from the surface of its second end member 72, wherein the ground lead 74, which is located in a center area of the surface of the second end member 72, is surrounded by the-signal leads 73-1˜73-4, which are located in a peripheral area of the surface of the second end member 72.

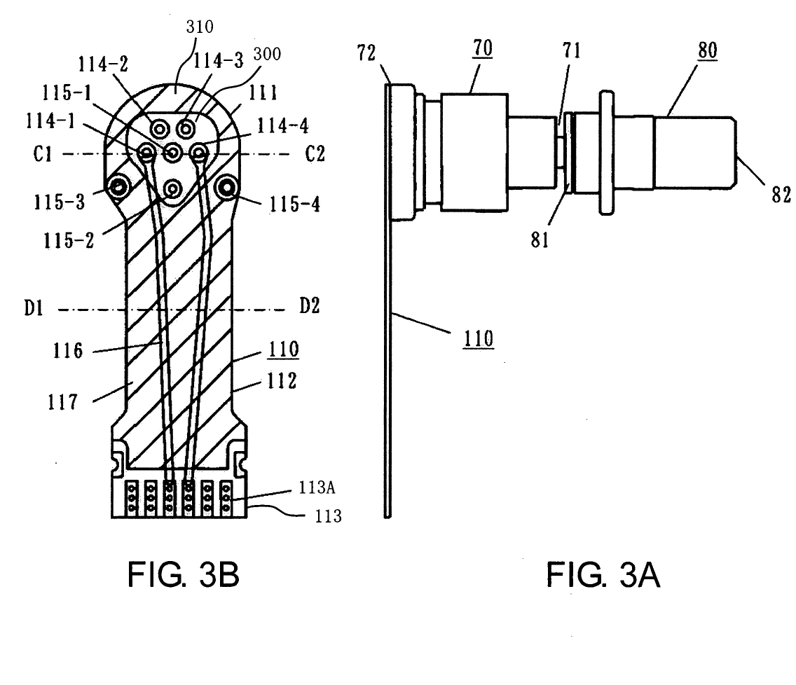

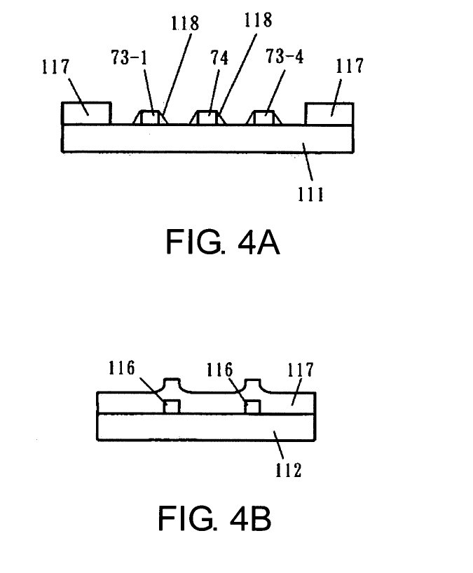

As shown in FIGS. 3A and 3B, the flexible substrate 110, which is connected to the second end member 72 of the first optical module 70, consists of a circular shaped first region 111 for fixing the signal leads 73-1˜73-4 and the ground leads 14, a rectangularly-shaped second region 113 in which terminals 113A are formed, and a rectangularly-shaped third region 112 located between the first and the second regions 111 and 113. The first region 51 includes a pentagonal shaped center area 300 whose bottom side is located close to the edge of the flexible substrate and a peripheral area 310 surrounding the center area 300. In the first region 111, a plurality of through-holes 114-1˜114-4 (hereinafter they are called signal through-holes), each of which corresponds to one of the signal leads 73-1˜73-4, and a first through-hole 115-1 (hereinafter it is called a first ground through-hole), which corresponds to the ground lead 74, are formed in the center area 200. Further, at the vertex of the center area 300, which is farthest from the bottom side being located close to the edge of the flexible substrate, a second ground through-hole 115-2 is formed. Further, two through holes 115-3 and 115-4 (hereinafter it is called fixing through-holes) for fixing the flexible substrate 110 onto the second end member 72 are formed in the peripheral area at a location closed to the third region 112. The fixing through-holes 115-3 and 115-4 are located at the location also closed to the side edge of the flexible substrate 110, and the second ground through-hole 115-2 is located therebetween. As shown in FIG. 4A, each signal lead 73-1˜73-4 is inserted into one of the signal through-holes 114-1˜114-4, and then, is fixed by solder 118, and the ground lead 74 is inserted into the first ground through-hole 115-1, and then, is fixed by solder 118. The suppress part of each leads 73-1˜73-4 and 74 is trimmed, and as a result, the flexible substrate 110 is mounted on and is provisionally fixed to the first optical module 70 at the second end member 72. The signal through-holes 114-1˜114-4 are electrically connected to the terminals 113A by metalized trace 116 formed of beaten cupper and formed on the surface of the flexible substrate 110 in the third region 112. As shown in FIGS. 1B, 4A and 4B, the flexible substrate 110 in the peripheral area 310 of the first region 111 and in the entire third region 112 including the surface of the metalized trace 116 is covered by a protection layer 117. The flexible substrate 110 in the second region 113 including the surface of the terminals 53A is exposed. The fixing through-holes 115-3 and 115-4, which are covered by the protection layer 117, are filled with adhesive material, such as resin, so that the flexible substrate 110 at the first region 111 is firmly fixed to the first optical module 70 at the second end member 72 by specifically and mainly the adhesive material injected into the fixing through-holes 115-3 and 115-4.

A method of manufacturing the optical module device having the structure described above is explained as follows with reference to several drawings.

First, as shown in FIGS. 3A, 3B and 4A, each signal lead 73-1˜73-4 is inserted into one of the signal through-holes 114-1˜114-4, and then, is fixed by solder 118, and the ground lead 74 is inserted into the first ground through-hole 115-1, and then, is fixed by solder 118. The suppress part of each leads 13-1˜134 and 14 are trimmed, and as a result, the flexible substrate 110 is mounted on and provisionally fixed to the first optical module 70 at the second end member 72. Further, the fixing through-holes 115-3 and 115-4, which are covered by the protection layer 117, are filled with the adhesive material, such as resin, so that the flexible substrate 110 at the first region 111 is firmly fixed to the first optical module 70 at the second end member 72 by specifically the fixing through-holes 115-3 and 115-4.

Next, as shown in FIGS. 1A and 1B, by adding force to the flexible substrate 110, which is in condition shown in FIG. 3A, from the first optical module side (from the right to the left on the drawing), the flexible substrate 110 is bent at 90-degree angle along the bending line 111A (shown as the broken line), which is just under the location where the fixing through-holes 115-3 and 115-4 and the second ground through-holes 115-2 are disposed. Then, the second region 113 in which the terminals 113A are formed is mounted on unillustrated terminals formed of beaten cupper and formed on the print substrate 120 on which the electric components 121 are mounted, and then the second region 113 of the flexible substrate 110 is fixed on the print substrate 120 by solder.

Then, the second optical module 80 having the optical fiber 90, which is attached to a chassis 100, is optically coupled with the first optical module 80.

In such an optical module device described above, the first optical module 70 emits an optical signal from its first end member 72 in response to the electric signal outputted from the electric components 121. The optical signal is received at the second optical module 80, and then, is transmitted to the optical fiber 90. Otherwise, when the optical signal through the optical fiber 90 is emitted from the third end member 81 of the second optical module 80, the optical signal is received at the first end member 71 of the first optical module 70, and is transformed into the electric signal. The electric signal is transmitted to the electric components 121 mounted on the print substrate via the metalized trace 116 formed on the flexible substrate, and the predetermined electrical processes are performed in response to the electric signal.

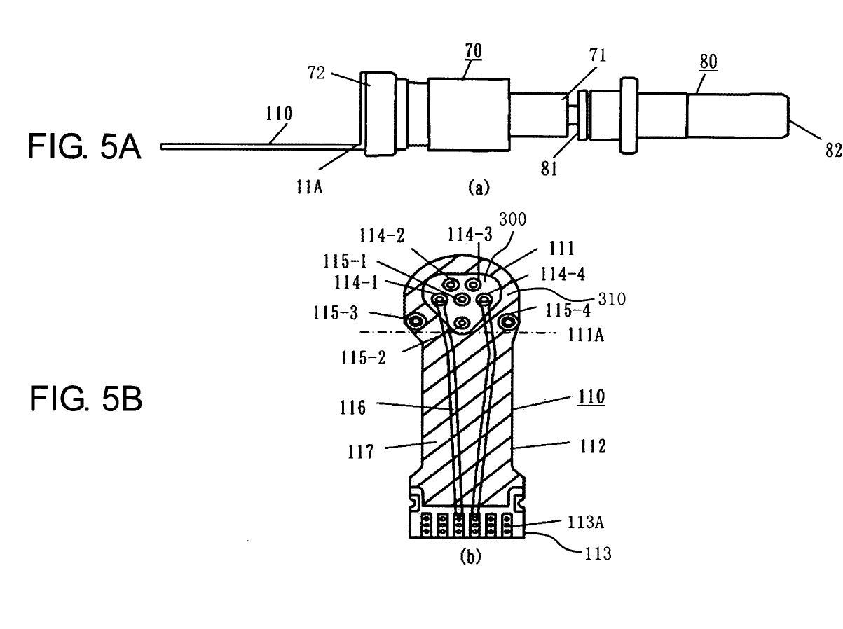

According to the optical module device 500 of the first embodiment, since the flexible substrate 110 is fixed on the second end member 71 of the first optical module by injecting the adhesive material into the fixing through-holes 115-3 and 115-4, which is covered by the protection layer 117. In other words, the flexible substrate 110 is fixed on the second end member 71 by the adhesive material injected into the fixing through-holes 115-3 and 115-4, which are located in the peripheral area of the first region at a location closed to the third region 112. Thus, as shown in FIGS. 5A and 5B, when the flexible substrate 110 is bent to the side where the print substrate 120 is disposed, the bending stress is concentrated at the bending line 111A, which is just under the fixing through-holes 115-3 and 115-4. At the bending line 111A, the metalized trace 116 is covered by the protection layer 117 so that the metalized traces 56 are not broken.

### The Second Embodiment

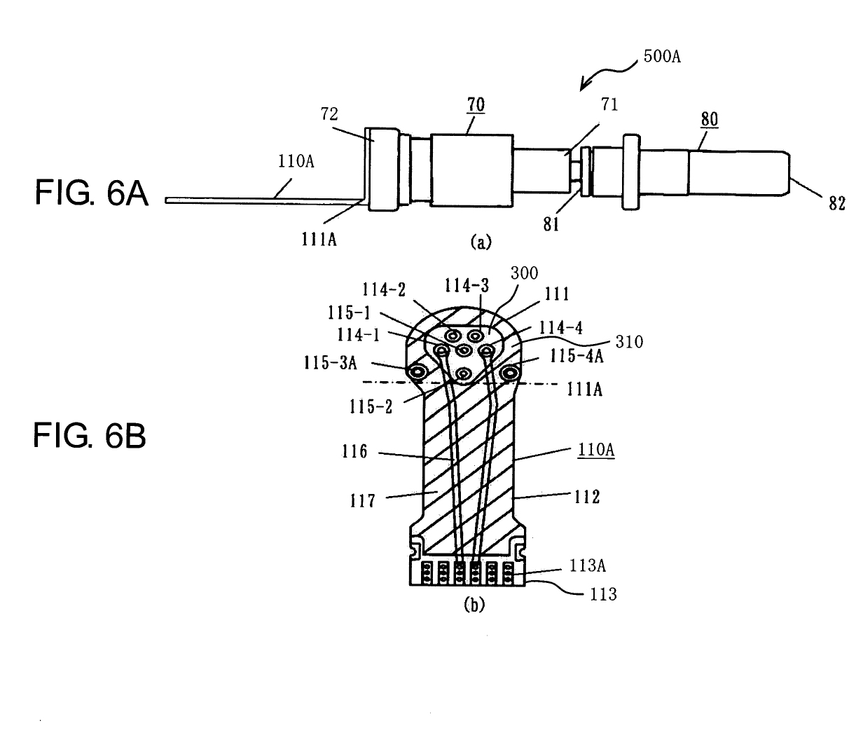

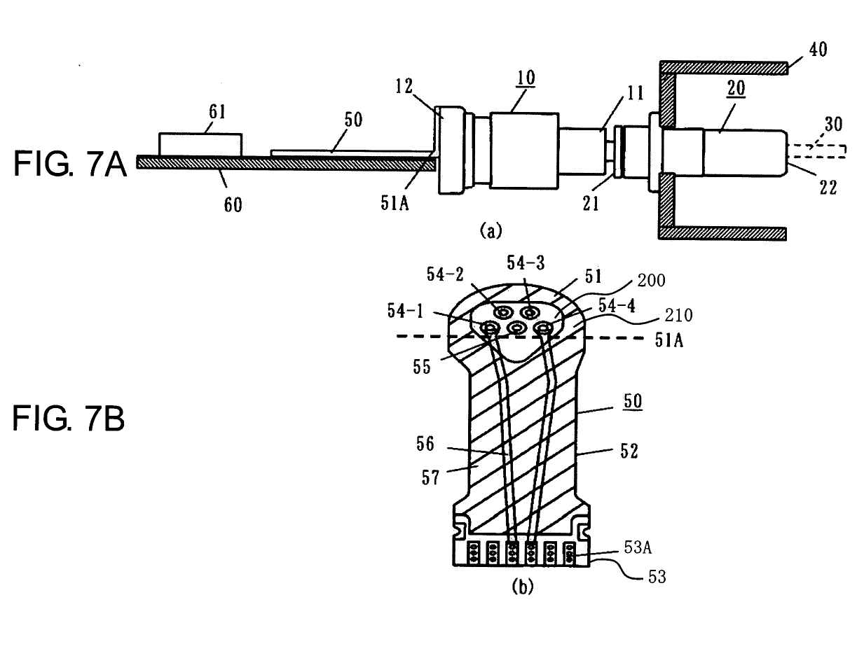

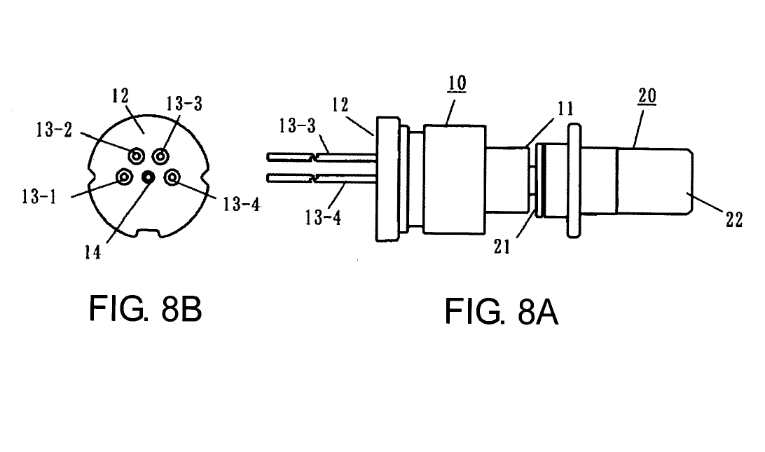

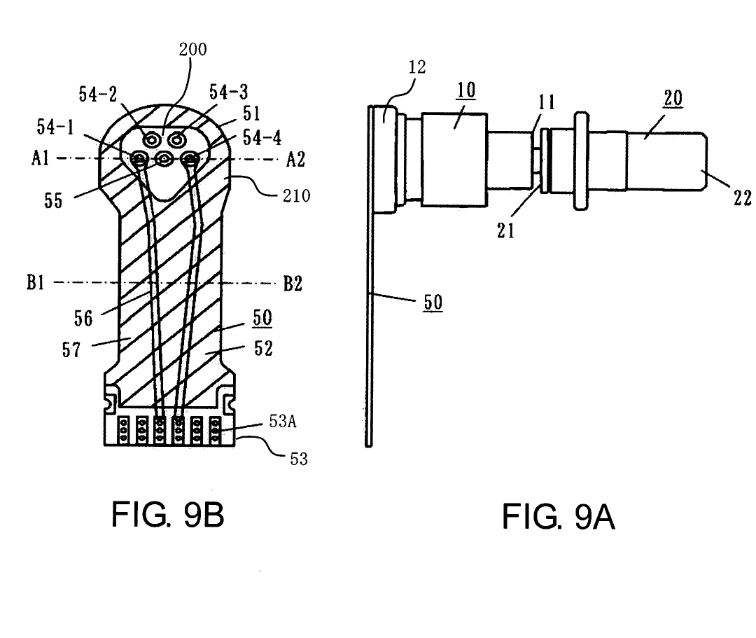

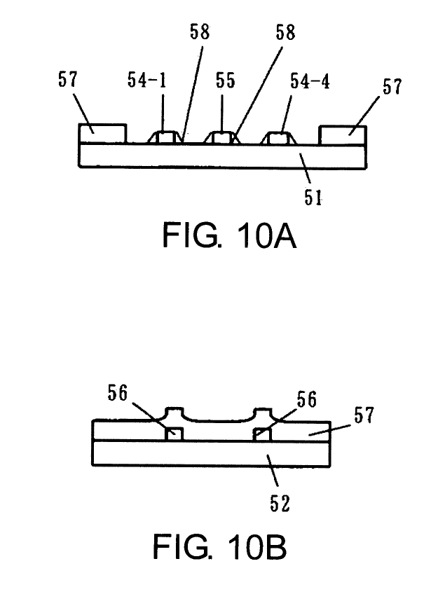

An optical module device 500A of the second embodiment is explained below with reference to FIGS. 6A and 6B. FIG. 6A is a left-side view of an optical module device on which a flexible substrate is connected to a first optical module, according to a second embodiment, and FIG. 6B is a plan view of the flexible substrate being attached to the first optical module.

The optical module device 500A includes a flexible substrate 110A. The other components used in the optical module device 500A are the same as these used in the optical module device 500 of the first embodiment.

The flexible substrate 110A includes the third ground through-holes 115-3A and 115-4A instead of the fixing through-holes 115-3 and 115-4 used in the first embodiment. The other components used in the flexible substrate 110A are the same as these used in the flexible substrate 110 of the first embodiment. The third ground through-holes 115-3A and 115-4A is formed in the same location where the fixing through-holes 115-3 and 115-4 used in the first embodiment are disposed. The third ground through-holes 115-3A and 115-4A are used for connecting unillustrated ground terminals of the flexible substrate 110A to unillustrated ground terminals of the second end member 72 of the first optical module 70. Thus, according to the second embodiment, the flexible substrate 110A is electrically and physically connected to the second end member 72 of the first optical module 70 by injecting the conductive material, such as silver paste, into the ground through-holes 115-3A and 115-4A. Thus, the conductivity and connectivity between the flexible substrate 110A and the second end member 72 of the first optical module 70 are secured by the conductive material.

According to the optical module device 500A of the second embodiment, in addition to the all benefits expected in the first embodiment, the ground connection between the flexible substrate 110A and the second end member 72 of the first optical module 70 is effectively-reinforced. For example, In the case that the first optical module 70 is formed by a semiconductor Laser, when the semiconductor Laser is operated in the rate of 10 Gb/s, it is possible to observe the fine eye patterns, and thus, to increase an optical coupling efficiency.

While the invention has been described with reference to illustrative embodiments, this description is not intended to be construed in a limiting sense. Thus, shapes, size and physical relationship of each component are roughly illustrated so the scope of the invention should not be construed to be limited to them. Further, to clarify the components of the invention, hatching is partially omitted in the cross-sectional views. Moreover, the numerical description in the embodiment described above is one of the preferred examples in the preferred embodiment so that the scope of the invention should not be construed to limit to them.

Various other modifications of the illustrated embodiment will be apparent to those skilled in the art on reference to this description. Therefore, the appended claims are intended to cover any such modifications or embodiments as fall within the true scope of the invention.

What I claim is:

1. An optical module device device, comprising:
an optical module having a first end member at which an optical signal is transmitted and a second end member from which a plurality of leads are projected;
a flexible substrate including a first region having a center area and a peripheral area at its one end, a second region at its other end and a third region between the first and the second regions, the flexible substrate including a plurality of first through-holes in which the leads are to be inserted in the center area, a terminal formed on its surface in the second region, a metalized trace formed on its surface in the third region for connecting one of the first through holes to the terminal and a protection layer formed on its surface at the peripheral area in the first region and in the third region,
wherein the flexible substrate further includes at lease two second through-holes in the peripheral area in the first region, which is a location close to the third region,
wherein the flexible substrate is bent along a bending line coupling the two second through-holes, and
wherein the flexible substrate at it first region is fixed to the second end member of the optical module by adhesive material injected into the second through-holes; and
a print substrate on which an electric component connecting to the terminal is mounted.

2. An optical module device as claimed in claim 1, wherein the optical module is a first optical module, further comprising:
a second optical module having a third end member, which is optically coupled and physically connectable and disconnectable with the first end member of the first optical module, and a fourth end member to which an optical fiber is connected.

3. An optical module device as claimed in claim 1, wherein the adhesive material is resin.

4. An optical module device as claimed in claim 1, wherein the second through-holes are being used for gerund connection, and the adhesive material is conductive adhesive material,
whereby ground of the optical module is connected to the flexible substrate via the conductive material.

5. An optical module device as claimed in claim 1, wherein the first through-holes are connected to the leads by solder.

6. An optical module device as claimed in claim 1, wherein the center area pentagonal shaped, and the bottom side of the center area is located close to the edge of the flexible substrate, and one of the vertex of the center area, which is farthest from the bottom side, is located close to the edge of the flexible substrate, and wherein each second through-hole is located one of the side of the vertex of the center area.

7. An optical module device as claimed in claim 6, wherein each second through-holes is located closed to the side of the flexible substrate.
